(19) United States
(12) Patent Application Publication
(10) Pub. No.: US 2003/0235049 A1
(43) Pub. Date: Dec. 25, 2003

(54) Decoration bulb assembly

(76) Inventor: Hsin-Hsien Wu, Taipei City (TW)

Correspondence Address: CHARLES E. BAXLEY, ESQUIRE, Hart, Baxley, Daniels & Holton, 59 John St, 5 Fl, New York, NY, 10038, US

(21) Appl. No.: 10/174,475

(22) Filed: Jun. 19, 2002

(51) Int. Cl. F21V 21/00; F21S 8/06

(52) U.S. Cl. 362/252; 362/249; 362/806; 362/391; 362/404

(57) ABSTRACT

A decoration bulb assembly includes a base and an adapter is connected to the base. A plurality of main wires extend from the adapter and a plurality of bulbs connected to the main wires. The base is connected to an electric socket to power the bulbs.

### FIELD OF THE INVENTION

The present invention relates to a bulb assembly that has a base with an adapter and a plurality of wires with bulbs extend from the base which is conveniently connected to the electric socket on the wall.

### BACKGROUND OF THE INVENTION

A conventional decoration bulb assembly such as a Christmas bulb assembly is shown in FIG. 1 and generally includes plug 11 and a main wire 11 extends from the plug and a plurality of branch wires 110 extend from the main wire 11. Each branch wire 110 has a bulb 12 connected thereto so that the bulbs 12 are powered and light up when the plug 1 is plunged in. An inherent shortcoming is that the length of the main wire 11 is limited so that an extension wire set is necessary so that the bulbs 12 can be put at a desired position. The main wire 11 is to be hung by hooks or support pieces which are fixed to the wall and a ladder is used to put the main wire 11 in the hooks at high position. The hooks are then removed from the wall after Christmas and holes are left in the wall.

The present invention intends to provide a bulb assembly which has a base which is connected to the electric socket to have the electric power.

### SUMMARY OF THE INVENTION

In accordance with one aspect of the present invention, there is provided a decoration bulb assembly which comprises a base and at least one main wire is connected to the base. At least one bulb is connected to the main wire. The base is to be connected to the electric socket.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a conventional Christmas bulb assembly;

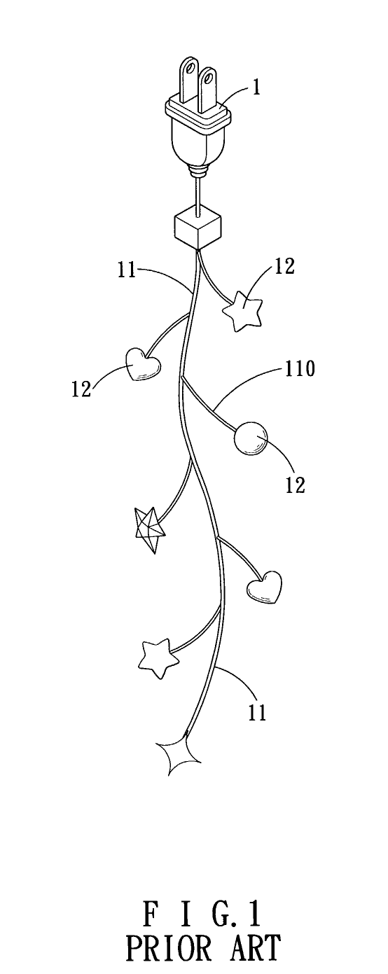

FIG. 2 shows the decoration bulb assembly of the present invention;

FIG. 3 shows the base of the decoration bulb assembly of the present invention is connected to the electric socket;

FIG. 4 shows the decoration bulb assembly of the present invention and electric socket; and

FIG. 5 shows another embodiment of the decoration bulb assembly of the present invention.

### DETAILED DESCRIPTION OF THE PREFERRED EMBODIMENT

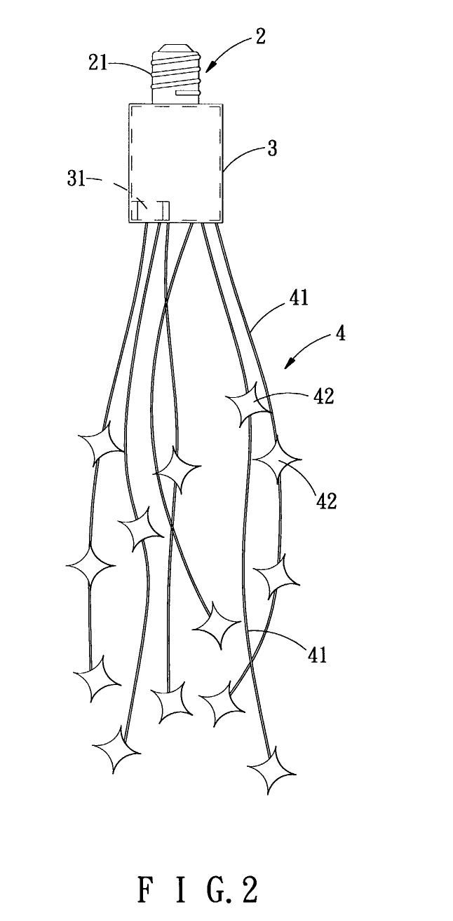

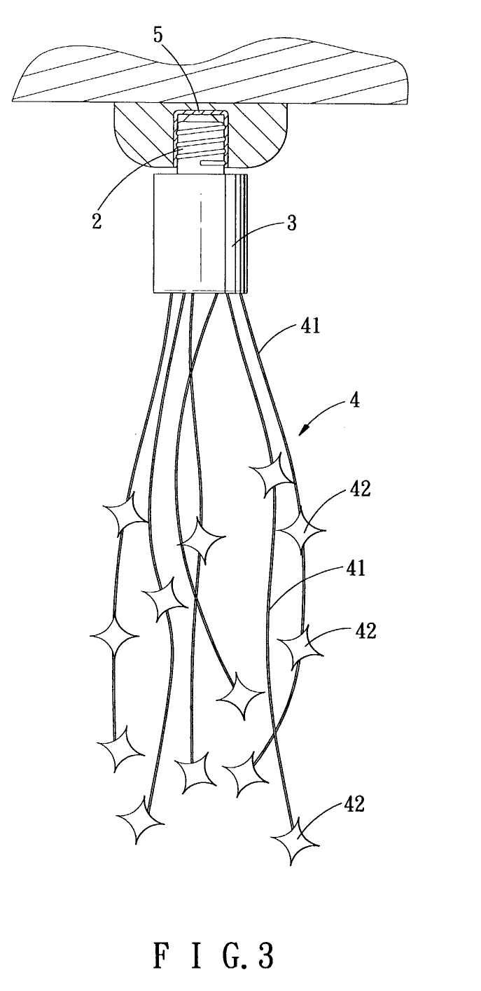

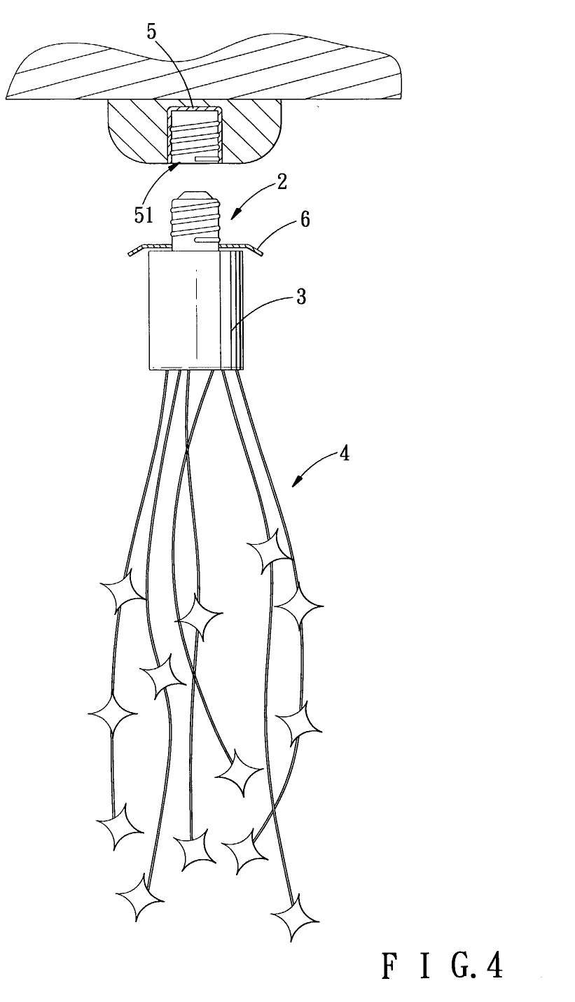

Referring to FIGS. 2 and 3, the decoration bulb assembly of the present invention comprises a base 2 which has threads 21 defined in an outer periphery thereof so as to be engaged with the inner threads 51 (FIG. 4) in an electric socket 5. An adapter 3 is connected to the base 2 and includes a fuse 31.

A bulb set 4 is connected to the adapter 3 and includes a plurality of flexible main wires 41 connected to the adapter 3 and a plurality of bulbs 42 are connected to each of the main wires 41. The adapter 3 provides the bulbs 42 proper voltage to protect the bulbs 42.

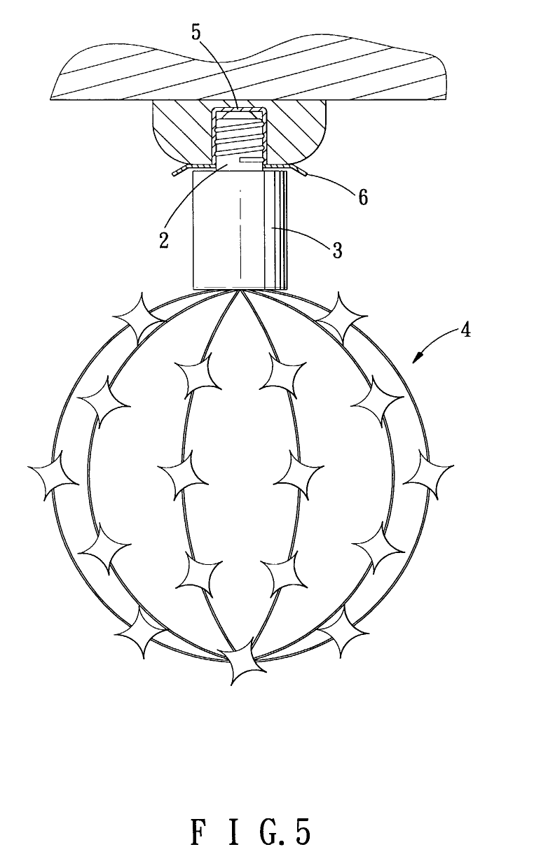

Referring to FIGS. 4 and 5, a seal pad 6 is mounted to the base 2 and provides a water seal between the base 2 and the socket 5. The main wires 41 may be arranged as a sphere shown in FIG. 5 or any other known patterns.

The decoration bulb assembly of the present invention does not need any support hook and can be connected to the socket 5 directly so that no wire extension set is needed and the bulbs 42 are protected by fuse 31 which ensures the safety of use.

While we have shown and described the embodiment in accordance with the present invention, it should be clear to those skilled in the art that further embodiments may be made without departing from the scope of the present invention.

What is claimed is:

1. A decoration bulb assembly comprising:
a base which is adapted to be connected to an electric socket, at least one main wire connected to the base and at least one bulb connected to the main wire.

2. The assembly as claimed in claim 1 further comprising an adapter connected between the base and the at least one main wire, the adapter having a fuse connected thereto.

3. The assembly as claimed in claim 1 further comprising a seal pad mounted to the base.

4. The assembly as claimed in claim 1 wherein the at least one main wire is flexible.
